(19) United States
(12) Patent Application Publication
(10) Pub. No.: US 2009/0281652 A1
(43) Pub. Date: Nov. 12, 2009

(54) CONTROLLER OF THREE-AXIS TOOL UNIT AND WORKING MACHINE

(75) Inventors: Isao TASHIRO, Osaka (JP); Masayuki TAKAHASHI, Osaka (JP)

Correspondence Address: STEPTOE & JOHNSON LLP, 1330 CONNECTICUT AVE., NW, WASHINGTON, DC, 20036, US

(73) Assignee: Panasonic Corporation, Kadoma-shi (JP)

(21) Appl. No.: 12/432,016

(22) Filed: Apr. 29, 2009

(30) Foreign Application Priority Data
May 7, 2008 (JP) 2008-120831

(51) Int. Cl. G05B 19/404

(52) U.S. Cl. 700/178

(57) ABSTRACT

An object of the present invention is to provide a controller of a three-axis tool unit which can compensate for mutual interference caused by the dynamic behaviors of three axes for operating a tool in three directions orthogonal to one another. The controller of the three-axis tool unit of the present invention includes a noninteracting control section which calculates, by using transfer functions, correction values for compensating for mutual interference caused by the dynamic behaviors of a first mechanism including a first actuator, a tool holder, and the tool, a second mechanism including a second actuator, the tool holder, and the tool, and a third mechanism including a third actuator, the tool holder, and the tool, and corrects the target displacements of the first, second, third actuators by using the correction values, the transfer functions indicating mutual influence of the dynamic behaviors of the first, second, and third mechanisms.

### FIELD OF THE INVENTION

The present invention relates to a controller of a three-axis tool unit capable of minutely operating a tool in three axial directions orthogonal to one another, and a working machine in which the three-axis tool unit is mounted.

### BACKGROUND OF THE INVENTION

In the prior art, methods for machining nonaxisymmetric aspherical shapes have required quite a long machining time. Thus, in recent years, working machines have been proposed which can machine precision components such as optical components having nonaxisymmetric aspherical shapes, according to axisymmetric machining typified by lathe turning. Such working machines are disclosed in, for example, Japanese Patent Laid-Open No. 2007-075915 and Japanese Patent Laid-Open No. 2007-307663. These working machines can shorten a machining time of complicated nonaxisymmetric aspherical shapes.

First, the working machine disclosed in Japanese Patent Laid-Open No. 2007-075915 will be described below. The working machine includes a cutting tool which is supported so as to be displaced in three different directions. When the working machine performs cutting, the cutting tool is displaced independently in the three directions according to a relative displacement of the cutting tool with respect to a work material.

FIG. 12 is a schematic diagram showing a cutting device disclosed in Japanese Patent Laid-Open No. 2007-075915 according to the prior art. FIG. 13 is a control block diagram of the cutting device.

A cutting device 101 is provided on a lathe for ultra-precision machining (not shown). A work material 102 is attached to the main spindle of the lathe. The work material 102 is rotated by rotation of the main spindle. The rotation direction is indicated by arrow B in FIG. 12. A housing 103 of the cutting device 101 moves in one axial direction relative to the main spindle of the lathe. The axial direction is indicated by arrow A in FIG. 12.

A mounting block 105 supports a cutting tool 104. The mounting block 105 is attached to the housing 103 via a first actuator 106, a second actuator 107, and a third actuator 108.

The first actuator 106, the second actuator 107, and the third actuator 108 are respectively displaced in the X-axis direction, the Y-axis direction, and the Z-axis direction which are orthogonal to one another relative to the housing 103. According to the displacements of the first actuator 106, the second actuator 107, and the third actuator 108, the mounting block 105 is displaced in the X-axis direction, the Y-axis direction, and the Z-axis direction relative to the housing 103. The first actuator 106, the second actuator 107, and the third actuator 108 are each made up of a piezoelectric element.

An X-axis displacement sensor 109a, a Y-axis displacement sensor 109b, and a Z-axis displacement sensor 109c are attached to the housing 103. Measured pieces 116a, 116b, and 116c are attached to the mounting block 105. The X-axis displacement sensor 109a, the Y-axis displacement sensor 109b, and the Z-axis displacement sensor 109c measure the displacements of the mounting block 105 relative to the housing 103 in the axial directions (X axis, Y axis, and Z axis) by measuring distances from the measured pieces 116a, 116b and 116c. In other words, the displacements of the cutting tool 104 are measured in the axial directions. The X-axis displacement sensor 109a, the Y-axis displacement sensor 109b, and the Z-axis displacement sensor 109c are each made up of a capacitance sensor.

A controller 110 of FIG. 13 reads in real time the position coordinates of the cutting tool 104 in the direction indicated by the arrow A in FIG. 12 and the rotational position coordinates of the main spindle of the lathe. A real-time target value arithmetic section 111 is provided in the controller 110. The real-time target value arithmetic section 111 calculates target positions of the cutting tool 104 in the axial directions (X axis, Y axis, and Z axis), that is, target displacements of the first actuator 106, the second actuator 107, and the third actuator 108 according to the read coordinates. These calculations are made based on predetermined formulas. Feedback control is performed on the first actuator 106, the second actuator 107, and the third actuator 108 so as to displace the cutting tool 104 to the target positions of the respective axes.

To be specific, an X-axis feedback control system is made up of a PID controller 112a, a D/A converter 113a, an amplifier 115a, and an A/D converter 114a. The displacement having been detected by the X-axis displacement sensor 109a is fed back to the X-axis feedback control system. In other words, the displacement of the cutting tool 104 in the X-axis direction is fed back. The X-axis feedback control system controls the first actuator 106 so as to displace the cutting tool 104 to the X-axis target position having been calculated by the real-time target value arithmetic section 111. The second actuator 107 and the third actuator 108 are controlled like the first actuator 106.

As has been discussed, the cutting device 101 can displace the cutting tool 104 independently in the three X-axis, Y-axis, and Z-axis directions through feedback control. Thus, the cutting device 101 can transfer any three-dimensional shape on a surface of the work material 102.

The following will describe the working machine disclosed in Japanese Patent Laid-Open No. 2007-307663. The working machine machines a workpiece with a three-axis tool unit. The three-axis tool unit includes three actuators, a tool holder, and a tool. The three actuators expand and contract in three axial directions (X, Y and Z) orthogonal to one another. The tool holder is provided at the intersection of the axes of the operating directions of the three actuators. The tool is attached to the tool holder. The working machine can minutely operate the tool independently in the X-axis, Y-axis and Z-axis directions by driving the three actuators. Further, the working machine can correct a positioning error of the cutting edge of the tool. The positioning error of the cutting edge of the tool is caused by rotations around the X, Y and Z axes (three axes) of the tool holder. Thus, the working machine can precisely position the cutting edge of the tool.

FIG. 14 shows a control block of the working machine disclosed in Japanese Patent Laid-Open No. 2007-307663 according to the prior art, and the three-axis tool unit mounted in the working machine.

As shown in FIG. 14, one end of each of three actuators 202, 203, and 204 is fixed on a support 201 of the three-axis tool unit. The three actuators 202, 203, and 204 expand and contract respectively in the three axial directions (X, Y, and Z axes) of the three-axis tool unit, the axial directions being orthogonal to one another. A tool holder 205 is provided at the intersection of the axes of the operating directions of the actuators 202, 203, and 204. A tool 206 is attached to the tool holder 205. The tool holder 205 is displaced by the expansion and contraction of the actuators 202, 203, and 204.

As shown in FIG. 14, three sensors 207, 208, and 209 are fixed on the support 201 of the three-axis tool unit and sensor targets 210, 211, and 212 are provided on the tool holder 205. The sensor targets 210, 211, and 212 are displaced according to the displacement of the tool holder 205. These three sensors 207, 208, and 209 measure the displacements of the actuators 202, 203, and 204 by sensing distances to the sensor targets 210, 211, and 212. In other words, the displacements of the tool 206 in the three axial directions are measured. The sensors 207, 208, and 209 are disposed such that the axes of the sensing directions intersect at one point.

As shown in FIG. 14, feedback control is performed on the actuators 202, 203, and 204 through adders 213, phase compensating sections 214, and amplifiers 215. The following will specifically describe an example of feedback control on the Z axis. The adder 213 calculates a deviation between a target displacement of the actuator 204, that is, a Z-axis target value and the displacement of the actuator 204, the displacement having been measured by the sensor 209. The phase compensating section 214 performs phase compensation such as integration (I control), proportion/integration (PI control), and proportion/integration/differentiation (PID control) on the deviation having been calculated by the adder 213. The amplifier 215 power-amplifies a signal from the phase compensating section 214 to generate a signal for driving the actuator 204.

A real-time target value arithmetic section 216 is fed with, in real time, three-axis coordinates of an X/Z-axis table (not shown) and a Y-axis table (not shown) of the working machine and angular coordinates of a rotary table (not shown) of the working machine, and calculates target displacements of the actuators 202, 203, and 204, that is, X-axis, Y-axis, and Z-axis target values in real time according to the coordinates.

When the actuators 202, 203, and 204 expand and contract, the tool holder 205 is pushed and pulled from the actuators 202, 203, and 204 and causes elastic strain, that is, elastic deformation on the actuators 202, 203, and 204. The force of elastic strain rotates the tool holder 205 around the X, Y, and Z axes (three axes). The axes of the sensing directions of the sensors 207, 208, and 209 are the centers of the rotations around the three axes of the tool holder 205. The rotations around the three axes of the tool holder 205 cause a positioning error on the cutting edge of the tool 206.

Thus, in this working machine, the sensors 207, 208, and 209 are disposed such that the axes of the sensing directions intersect at one point. When the sensors 207, 208, and 209 are disposed thus, the intersection (the one point) of the axes of the sensing directions is the center of rotations around the three axes of the tool holder 205. When the center of rotations and the cutting edge of the tool 206 are aligned with each other, the positioning of the cutting edge is less affected by the rotations around the three axes of the tool holder, so that the cutting edge is positioned with high accuracy.

In some cases, however, it is difficult to align the center of rotations and the cutting edge of the tool. For example, in the case where the sensors and a workpiece come into contact with each other during machining because the center of rotations and the cutting edge of the tool are aligned with each other, the position of the cutting edge has to be offset from the center of rotations. When the cutting edge of the tool 206 is offset from the center of rotations, a positioning error occurs on the cutting edge of the tool 206. This error is not negligible in precision components such as optical components requiring accuracy of form on the order of submicron.

In this working machine, a rotation angle arithmetic section 217 and a tool cutting edge positioning error arithmetic section 218 calculate a positioning error generated on the cutting edge of the tool 206, the positioning error being caused by rotations around the three axes of the tool holder 205. By using the calculated amount of error, the real-time target value arithmetic section 216 corrects the target displacements of the actuators 202, 203, and 204.

To be specific, the rotation angle arithmetic section 217 calculates a rotation angle α around the X axis, a rotation angle β around the Y axis, and a rotation angle γ around the Z axis of the tool holder 205 at the center of rotations, based on the target displacements of the actuators 202, 203, and 204, the target displacements having been calculated by the real-time target value arithmetic section 216. The tool cutting edge positioning error arithmetic section 218 calculates a positioning error occurring on the cutting edge of the tool 206, based on the rotation angles α, β, and γ, which have been calculated by the rotation angle arithmetic section 217, around the three axes and a distance from the center of rotations to the cutting edge of the tool 206. The real-time target value arithmetic section 216 is fed with in real time the amount of error having been calculated by the tool cutting edge positioning error arithmetic section 218 and corrects the target displacements of the actuators 202, 203, and 204.

In this way, the working machine compensates for the positioning error of the cutting edge of the tool, the positioning error being caused by rotations around the three axes of the tool holder. Thus, the working machine of the prior art can position the tool three-dimensionally with high accuracy.

As has been discussed, the working machine of the prior art positions the cutting edge of the tool by performing feedback control on the three-axis actuators which expand and contract in the X-axis, Y-axis and Z-axis directions.

FIG. 15 shows the evaluation results of step response when a command of 0.25-μm step feed is issued to the Z-axis actuator. In this example, since the step feed has a small step width of 0.25 μm, it appears that the tool is not displaced in the X-axis and Y-axis directions.

However, when the actuators are largely displaced, mutual interference caused by the dynamic behaviors of an X-axis mechanism, a Y-axis mechanism, and a Z-axis mechanism cannot be compensated only by feedback control on the three-axis actuators. In this case, the X-axis mechanism is made up of the X-axis actuator, the tool holder or a mounting block, and the tool. The Y-axis mechanism is made up of the Y-axis actuator, the tool holder or a mounting block, and the tool. The Z-axis mechanism is made up of the Z-axis actuator, the tool holder or a mounting block, and the tool.

FIGS. 16 and 17 show the operations of the tool when the X-axis actuator is fed with a half-wave voltage signal of a sin wave having a frequency of about 26 Hz and an amplitude of 25 μm. FIG. 16 shows open loop control on the three-axis actuators and FIG. 17 shows feedback control on the three-axis actuators. In either case, the tool is operated also in the Y-axis direction and the Z-axis direction according to the dynamic behaviors of the X-axis mechanism.

The operations of the tool in the Y-axis direction and the Z-axis direction in FIG. 17 indicate that the dynamic behaviors of the X-axis mechanism cause disturbance in the Y-axis and Z-axis feedback control systems. In other words, although feedback control is performed on the Y-axis and Z-axis actuators so as to cancel operations of disturbance, the actuators are not sufficiently controlled and are still affected by interference from the X-axis mechanism depending on the response characteristics of feedback control. The influence of interference increases with an operating speed and an operating distance. Thus, when the actuators are largely displaced, mutual interference caused by the dynamic behaviors of the X-axis, Y-axis, and Z-axis mechanisms cannot be compensated only by feedback control on the actuators, so that the machining accuracy decreases. Particularly, dies for optical components require accuracy of nanometer order to submicron order, so that the machining accuracy reduced by the interference is not negligible.

Further, a static error can be compensated by the working machine configured to compensate for a positioning error on the cutting edge of the tool, the positioning error being caused by rotations around the three axes of the tool holder. The static error is caused by static behaviors caused such that when forces are applied to the three-axis actuators by the expansion and contraction of the three-axis actuators, the force rotates the tool holder around the three axes, and a positioning error occurs on the cutting edge of the tool. However, the working machine capable of compensating for such a static error cannot compensate for a dynamic error occurring because of mutual interference caused by the dynamic behaviors of the X-axis, Y-axis, and Z-axis mechanisms.

When the positioning error of the cutting edge of the tool cannot be compensated, the positioning error being caused by rotations around the three axes of the tool holder, the error remains even after the expansion and contraction of the actuators are stopped. On the other hand, an error occurring because of mutual interference caused by the dynamic behaviors of the X-axis, Y-axis, and Z-axis mechanisms can be eliminated by feedback control after the expansion and contraction of the actuators are stopped (see FIG. 17).

As has been discussed, when the three axes of the X-axis, Y-axis, and Z-axis mechanisms are coupled to one another, the dynamic behavior of one of the axes causes a push and a pull to and from the other axes and a dynamic error occurs because of the mutual interference of the three axes. The dynamic error caused by mutual interference becomes more noticeable as the operation becomes larger and the operating speed increases.

### DISCLOSURE OF THE INVENTION

The present invention has been devised in view of the problems. An object of the present invention is to provide a controller of a three-axis tool unit which can compensate for mutual interference caused by the dynamic behaviors of three axes for operating a tool independently in three directions orthogonal to one another, and a working machine. The three-axis tool unit includes: first, second, and third actuators operating in first, second, and third directions orthogonal to one another; a tool holder disposed at the intersection of axes of operating directions of the first, second, and third actuators; a tool attached to the tool holder to operate in the first, second, and third directions according to operations of the first, second, and third actuators; and first, second, and third sensors for measuring displacements of the first, second, and third actuators. The controller of the three-axis tool unit according to the present invention controls the operations of the first, second, and third actuators of the three-axis tool unit.

In order to attain the object, the controller of the three-axis tool unit according to a first aspect of the present invention includes a noninteracting control section which calculates, by using transfer functions, correction values for compensating for mutual interference caused by dynamic behaviors of a first mechanism including the first actuator, the tool holder, and the tool, a second mechanism including the second actuator, the tool holder, and the tool, and a third mechanism including the third actuator, the tool holder, and the tool, corrects target displacements of the first, second, third actuators by using the correction values, and controls the operations of the first, second, and third actuators by using the corrected target displacements and the displacements measured by the first, second, and third sensors, the transfer functions indicating mutual influence of the dynamic behaviors of the first, second, and third mechanisms.

Further, the transfer functions indicating the mutual influence of the dynamic behaviors of the first, second, and third mechanisms may be identified based on response measurement results.

A controller of a three-axis tool unit according to a second aspect of the present invention includes a noninteracting control section including a multivariable control algorithm for controlling the operations of the first, second, and third actuators by using models of a first mechanism including the first actuator, the tool holder, and the tool, a second mechanism including the second actuator, the tool holder, and the tool, and a third mechanism including the third actuator, the tool holder, and the tool, interference models indicating the mutual influence of dynamic behaviors of the first, second, and third mechanisms, target displacements of the first, second, and third actuators, and displacements measured by the first, second, and third sensors.

Moreover, the noninteracting control section may include a model predictive control algorithm as the multivariable control algorithm.

Further, the models of the first, second and third mechanisms and the interference models may be expressed by transfer functions. Moreover, the transfer functions may be identified based on response measurement results.

Further, the first, second, and third sensors may be disposed such that the axes of the sensing directions of the sensors intersect at one point.

A working machine of the present invention includes: the three-axis tool unit, a linear stage for relatively moving the three-axis tool unit in three axial directions orthogonal to a workpiece; a rotary stage for making the three-axis tool unit circulate relative to the workpiece; and a controller of one of the first and second three-axis tool units, wherein the controller of the three-axis tool unit calculates target displacements of the first, second, and third actuators according to a relative displacement of the three-axis tool unit with respect to the workpiece, the relative displacement being made by the rotary stage and the linear stage, and the controller controls the operations of the first, second, and third actuators by using the calculated target displacements.

Preferable embodiments of the present invention can compensate for mutual interference caused by the dynamic behaviors of three axes operating the tool independently in three directions orthogonal to one another. Thus, the preferable embodiments of the present invention can achieve precise machining.

### BRIEF DESCRIPTION OF THE DRAWINGS

FIG. 1 is a control block diagram showing a controller of a three-axis tool unit according to first to third embodiments of the present invention;

FIG. 2 is a schematic diagram showing the three-axis tool unit according to the first to third embodiments of the present invention;

FIG. 3 is a control block diagram showing a typical feedback control system;

FIG. 4 is a control block diagram showing a noninteracting control section according to the first embodiment of the present invention;

FIG. 5 shows an example of the operation of a tool controlled by the controller of the three-axis tool unit according to the first embodiment of the present invention;

FIGS. 6A and 6B show the simulation results of the controller of the three-axis tool unit according to the second embodiment of the present invention, FIG. 6A shows an output Yₓ of an X-axis sensor, and FIG. 6B shows an input uₓ to an X-axis actuator 3;

FIG. 7 shows an example of the operation of a tool which is controlled by the controller of the three-axis tool unit according to the second embodiment of the present invention;

FIG. 8 is a structural diagram showing a working machine according to the third embodiment of the present invention;

FIG. 9 is a schematic diagram showing a machining principle of a diffracted cylindrical shape according to the third embodiment of the present invention;

FIG. 10 is an explanatory drawing showing the derivation of the target values of actuators according to the third embodiment of the present invention;

FIGS. 11A and 11B are explanatory drawings showing machining results according to the third embodiment of the present invention, FIG. 11A shows two photographs taken of a surface of a workpiece having been machined under noninteracting control, with two different magnifications, and FIG. 11B shows two photographs taken of the surface of the workpiece having been machined without noninteracting control, with two different magnifications;

FIG. 12 is a schematic diagram showing a working machine according to the prior art;

FIG. 13 is a control block diagram showing the working machine according to the prior art;

FIG. 14 shows a control block of another working machine according to the prior art, and a three-axis tool unit mounted in the working machine;

FIG. 15 shows the evaluation results of step response in the working machine of the prior art;

FIG. 16 is an explanatory drawing showing mutual interference caused by dynamic behaviors of axes when open loop control is performed on the axes for displacing a tool in three axial directions in the working machine of the prior art; and

FIG. 17 is an explanatory drawing showing mutual interference caused by the dynamic behaviors of the axes when feedback control is performed on the axes for displacing the tool in the three axial directions in the working machine of the prior art.

### DESCRIPTION OF THE EMBODIMENTS

### First Embodiment

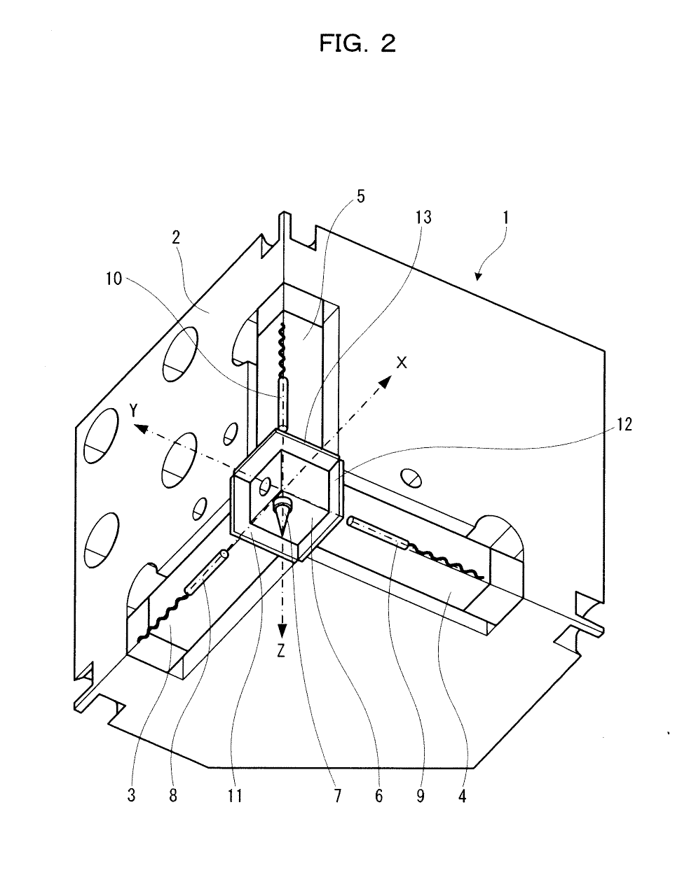

First, the following will describe a three-axis tool unit according to a first embodiment. FIG. 2 is a schematic diagram showing the three-axis tool unit according to the first embodiment of the present invention.

As shown in FIG. 2, one end of each of three actuators 3, 4, and 5 is fixed to a support 2 via mounting members. The actuators 3, 4, and 5 are examples of first, second, and third actuators. The three actuators 3, 4, and 5 expand and contract respectively in the X-axis, Y-axis, and Z-axis directions which are examples of first, second, and third directions orthogonal to one another.

The actuators 3, 4, and 5 may be configured using piezoelectric elements. For example, multilayer piezoelectric elements and the like mainly composed of PZT (PbZrO₃—PbTiO₃) may be used. In the case of high-precision processing, the machining accuracy is affected by the expansion and contraction of the components of the three-axis tool unit, the expansion and contraction being caused by a change in ambient temperature. Thus, the support 2 is desirably made of a low thermal expansion material.

A tool holder 6, which is an example of a tool holder, is attached to the other ends of the actuators 3, 4, and 5. The other ends of the actuators 3, 4, and 5 are opposite from the ends fixed to the support 2. The tool holder 6 is disposed at the intersection of the axes of the operating directions of the actuators 3, 4, and 5. A tool 7 is attached to the tool holder 6.

The tool holder 6 and the tool 7 are minutely operated independently in the three axial directions (X, Y and Z axes) as the actuators 3, 4, and 5 expand and contract. The tool holder 6 is also desirably made of a low thermal expansion material to increase the machining accuracy.

Further, on the support 2, three sensors 8, 9, and 10 are attached via a sensor holder (not shown). The sensors 8, 9, and 10 are examples of first, second, and third sensors. The sensor holder may include, for example, a fine adjustment mechanism using elastic deformation, in consideration of ease of adjustment during the installation of the sensors. The sensor holder is also desirably made of a low thermal expansion material to avoid malfunctions caused by thermal deformation.

Sensor targets 11, 12, and 13 to be measured by the sensors 8, 9, and 10 may be integrated with the tool holder 6 so as to be displaced according to a displacement of the tool holder 6. Alternatively, the sensor targets 11, 12, and 13 displaced according to a displacement of the tool holder 6 may be separated from the tool holder 6.

The three sensors 8, 9, and 10 measure displacements of the actuators 3, 4, and 5 by sensing distances to the sensor targets 11, 12, and 13. In other words, displacements of the tool 7 attached to the tool holder 6 are measured in the three axial directions.

The sensors 8, 9, and 10 may be well-known capacitance sensors, eddy-current sensors, optical fiber sensors, and the like. In order to operate the actuators with higher accuracy, capacitance sensors and optical fiber sensors are desirably used.

When the actuators 3, 4, and 5 are configured using piezoelectric elements, the piezoelectric elements expand and contract in response to voltages applied to the piezoelectric elements, so that the actuators 3, 4, and 5 expand and contract in the X-axis, Y-axis, and Z-axis directions. However, since the piezoelectric elements have hysteresis, the actuators 3, 4, and 5 cannot be precisely driven relative to target values of displacements in the X-axis, Y-axis, and Z-axis directions of the actuators 3, 4, and 5 only by applying voltages corresponding to the target values to the piezoelectric elements. Thus, in the first embodiment, characteristics with no hysteresis are achieved by feedback control.

When the actuators 3, 4, and 5 expand and contract, the tool holder 6 is pushed and pulled by the actuators 3, 4, and 5, elastic strain (elastic deformation) occurs on the actuators 3, 4, and 5, and the tool holder 6 is rotated around the X, Y and Z axes (three axes) by the force of the elastic strain. The axes of the sensing directions of the sensors 8, 9, and 10 are the centers of rotations around the three axes of the tool holder 6. Thus, when the sensors 8, 9, and 10 are disposed such that the axes of the sensing directions do not intersect at one point, the movements of the tool holder 6 become complicated. For this reason, here, the sensors 8, 9, and 10 are disposed such that the axes of the sensing directions intersect at one point (intersection). In the layout of the sensors 8, 9, and 10, the tool holder 6 is rotated about the intersection point. Thus, the operations of the tool holder 6 become less complicated and it is possible to easily identify transfer functions of axes (X-axis mechanism, Y-axis mechanism, Z-axis mechanism), which will be described layer.

The following will describe a controller of the three-axis tool unit according to the first embodiment. Even when feedback control is performed on the actuators 3, 4, and 5, the actuators 3, 4, and 5 with large displacements cause a dynamic error on the cutting edge of the tool 7 because of mutual interference caused by the dynamic behaviors of the X-axis, Y-axis, and Z-axis mechanisms which are examples of first, second, and third mechanisms. In other words, disturbance is applied to the feedback control system of one of the axes by the dynamic behaviors of the other operating axes. The X-axis mechanism is made up of the actuator 3, the tool holder 6, and the tool 7. The Y-axis mechanism is made up of the actuator 4, the tool holder 6, and the tool 7. The Z-axis mechanism is made up of the actuator 5, the tool holder 6, and the tool 7.

Although feedback control is performed on the actuator of one of the axes so as to cancel operations of disturbance, the actuator is not sufficiently controlled and is still affected by interference from the other axes depending on the response characteristics of feedback control. Mutual interference is thus generated by the dynamic behaviors of the X-axis, Y-axis, and Z-axis mechanisms.

The controller of the three-axis tool unit according to the first embodiment includes a noninteracting control section for compensating for the mutual interference. The noninteracting control section calculates correction values for compensating for the mutual interference caused by the dynamic behaviors of the X-axis, Y-axis, and Z-axis mechanisms, by using transfer functions indicating the mutual influence of the dynamic behaviors of the X-axis, Y-axis, and Z-axis mechanisms. Further, the noninteracting control section corrects the target displacements of the actuators 3, 4, and 5 by using the calculated correction values. Moreover, the noninteracting control section controls the actuators 3, 4, and 5 through the feedback control system (closed loop control system) by using the corrected target displacements and displacements measured by the sensors 8, 9, and 10.

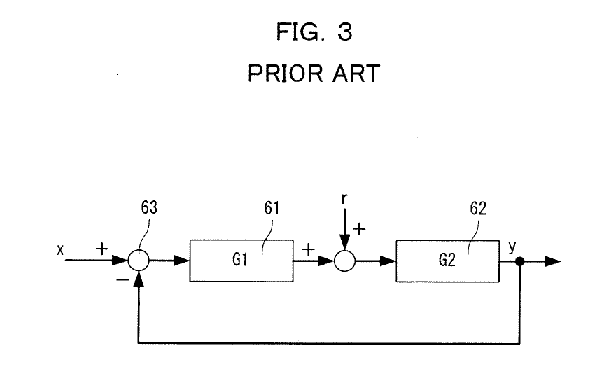

FIG. 3 shows a typical feedback control system. In FIG. 3, reference numeral 61 denotes a phase compensating section and reference numeral 62 denotes a control target. As shown in FIG. 3, in the typical feedback control system, an adder 63 calculates a deviation between a target value signal x and a feedback signal having a controlled variable y, and the phase compensating section 61 performs phase compensation to eliminate the calculated deviation. To the output (manipulated variable) of the phase compensating section 61, a disturbance r is added. The manipulated variable to which the disturbance r has been added is inputted to the control target 62, and the feedback signal having the controlled variable y is outputted from the control target 62.

When the feedback control system of FIG. 3 is used for, for example, the feedback control system of the Y-axis mechanism, the output of the phase compensating section 61 corresponds to a signal for driving the actuator 4 of the Y axis and the control target 62 corresponds to the Y-axis mechanism. The output y of the control target 62 corresponds to a displacement of the tool 7 in the Y-axis direction, that is, a displacement of the Y-axis actuator 4, the displacement being measured by the sensor 9. The disturbance r corresponds to interference from the X-axis mechanism or the Z-axis mechanism. In the block diagram of FIG. 3, the disturbance r is added to the output of the phase compensating section 61. In reality, the disturbance r is added to the output (operation) of the Y-axis mechanism and the result of the addition is outputted from the sensor 9 as a displacement of the tool 7 in the Y-axis direction. The adder 63 calculates a deviation between the target value signal x, which indicates the target displacement of the Y-axis actuator 4, and a signal from the sensor 9. The transfer function indicating the influence of the dynamic behavior (the influence of interference) of the X-axis mechanism or the Z-axis mechanism on the operation of the Y-axis mechanism is expressed as a transfer function from the disturbance r to the output y by formula 1 below:

$$\frac{y}{r} = \frac{G 2}{G 1 \cdot G 2 + 1} \qquad ( 1 )$$

where G1 is a transfer function of the phase compensating section 61 and G2 is a transfer function of the Y-axis mechanism (control target 62).

When the phase compensating section 61 performs PI control, the transfer function G1 of the phase compensating section 61 is expressed by formula 2 below:

$$G 1 = \frac{G ( Es + 1 )}{Ds + 1} \qquad ( 2 )$$

where D, E, and G are control parameters. A term (Es+1) is added to improve response.

The transfer function G2 of the Y-axis mechanism (control target 62) is, when the transfer function G2 is a second-order lag system, expressed by formula 3 below:

$$G 2 = \frac{C}{{s}^{2} + As + B} \qquad ( 3 )$$

where A, B, and C are parameters.

Based on formulas 2 and 3, formula 1 can be expressed as in formula 4 below:

$$\frac{y}{r} = \frac{C ( Ds + 1 )}{\begin{matrix}{Ds}^{3} + ( A \cdot D + 1 ) {s}^{2} + \\ ( A + B \cdot D + C \cdot E \cdot G ) s + C \cdot G + B\end{matrix}} \qquad ( 4 )$$

Formula 4 makes it possible to determine the magnitude of the output y resulted from the disturbance r, that is, the influence of the dynamic behavior (the influence of interference) of the X-axis mechanism or the Z-axis mechanism on the operation of the Y-axis mechanism. Thus, the output y is calculated based on formula 4 and the target value of the Y-axis actuator is corrected so as to cancel the operation of the Y-axis mechanism (output y), the operation being resulted from the disturbance r. Consequently, it is possible to compensate for interference from the X-axis mechanism or the Z-axis mechanism.

Formula 4 is expressed by a transfer function of a continuous system. In addition to the transfer function of the continuous system, processing may be performed using a transfer function discretized by Z conversion through bilinear conversion and so on. In other words, digital control may be performed using a micro processing unit (MPU) and the like.

Actually, the dynamic behavior of the X-axis mechanism affects the operations of the Y-axis mechanism and the Z-axis mechanism, the dynamic behavior of the Y-axis mechanism affects the operations of the X-axis mechanism and the Z-axis mechanism, and the dynamic behavior of the Z-axis mechanism affects the operations of the X-axis mechanism and the Y-axis mechanism. In other words, the dynamic behaviors of the X, Y, and Z axis mechanisms interfere with one another.

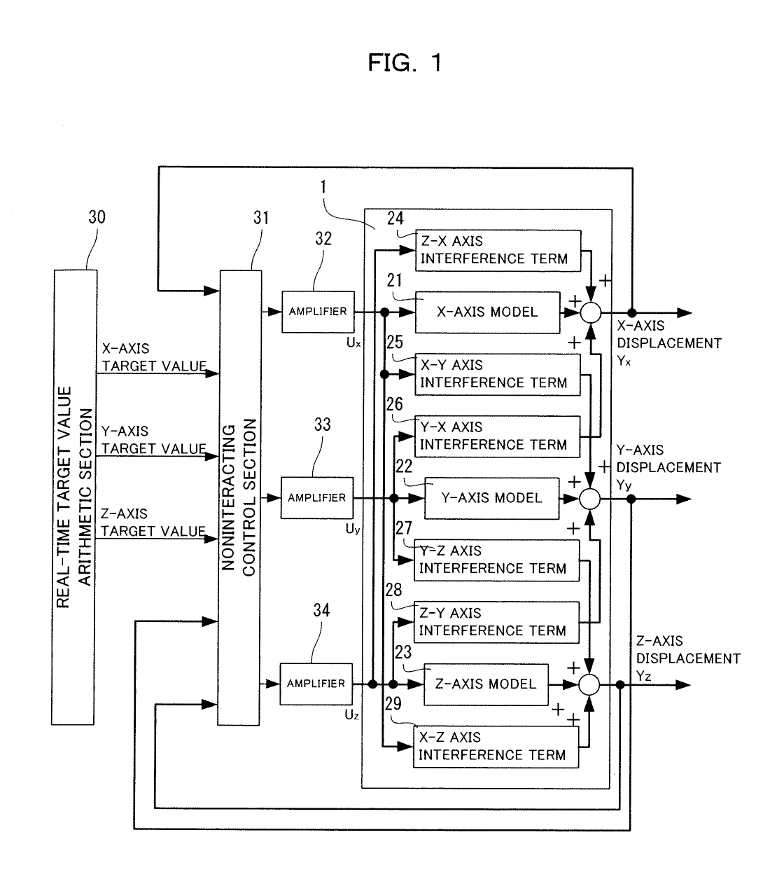

FIG. 1 is a control block diagram showing the controller of the three-axis tool unit according to the first embodiment of the present invention. FIG. 1 shows a configuration for compensating for mutual interference caused by the dynamic behaviors of the X-axis, Y-axis, and Z-axis mechanisms.

As shown in FIG. 1, a three-axis tool unit 1 is made up of an X-axis model 21 which is a model of the X-axis mechanism, a Y-axis model 22 which is a model of the Y-axis mechanism, a Z-axis model 23 which is a model of the Z-axis mechanism, an X-Y axis interference term 25 which indicates the influence of the dynamic behavior of the X-axis mechanism on the operation of the Y-axis mechanism, an X-Z axis interference term 29 which indicates the influence of the dynamic behavior of the X-axis mechanism on the operation of the Z-axis mechanism, a Y-X axis interference term 26 which indicates the influence of the dynamic behavior of the Y-axis mechanism on the operation of the X-axis mechanism, a Y-Z axis interference term 27 which indicates the influence of the dynamic behavior of the Y-axis mechanism on the operation of the Z-axis mechanism, a Z-X axis interference term 24 which indicates the influence of the dynamic behavior of the Z-axis mechanism on the operation of the X-axis mechanism, and a Z-Y axis interference term 28 which indicates the influence of the dynamic behavior of the Z-axis mechanism on the operation of the Y-axis mechanism.

The result of addition of outputs from the X-axis model 21, the Y-X axis interference term 26, and the Z-X axis interference term 24 is outputted from the sensor 8 as a displacement (X-axis displacement Yx) of the X-axis actuator 3. Similarly, the result of addition of outputs from the Y-axis model 22, the X-Y axis interference term 25, and the Z-Y axis interference term 28 is outputted from the sensor 9 as a displacement (Y-axis displacement Yy) of the Y-axis actuator 4. Further, the result of addition of outputs from the Z-axis model 23, the Y-Z axis interference term 27, and the X-Z axis interference term 29 is outputted from the sensor 10 as a displacement (Z-axis displacement Yz) of the Z-axis actuator 5.

A real-time target value arithmetic section 30 is fed with, in real time, the three-axis coordinates of a linear stage (not shown) for relatively moving the three-axis tool unit 1 in the three axial directions orthogonal to a workpiece, and the angular coordinates of a rotary stage (not shown) for making the three-axis tool unit 1 circulate relative to the workpiece. Further, the real-time target value arithmetic section 30 calculates the target displacements (X-axis target value, Y-axis target value, Z-axis target value) of the actuators 3, 4, and 5 in real time according to a relative displacement of the three-axis tool unit 1 with respect to the workpiece.

A noninteracting control section 31 is fed with the X-axis displacement Yx, the Y-axis displacement Yy, and the Z-axis displacement Yz, and is also fed with the X-axis target value, the Y-axis target value, and the Z-axis target value which have been calculated by the real-time target value arithmetic section 30, and then the noninteracting control section 31 outputs command signals for the actuators 3, 4, and 5 of the respective axes to amplifiers 32, 33, and 34 for the respective axes. The amplifiers 32, 33, and 34 power-amplify the command signals for the respective axes from the noninteracting control section 31 and generate signals for driving the actuators 3, 4, and 5.

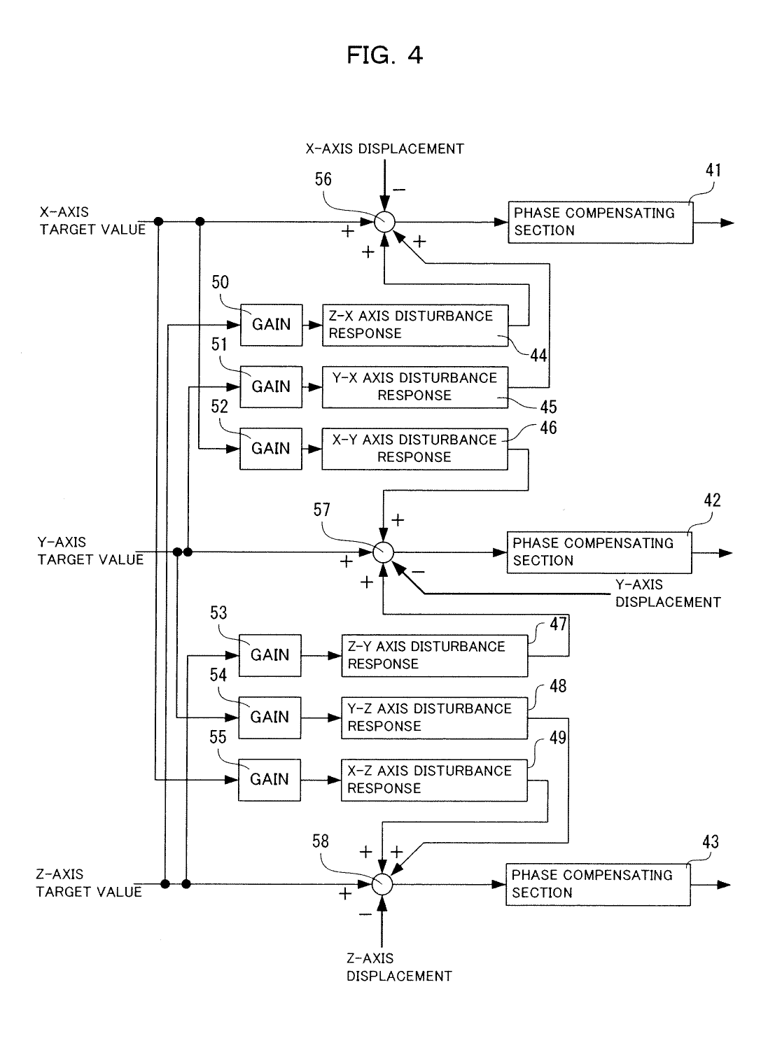

Referring to FIG. 4, the noninteracting control section 31 of the first embodiment will be specifically described below. FIG. 4 is a control block diagram showing the noninteracting control section 31 according to the first embodiment of the present invention. As shown in FIG. 4, in the noninteracting control section 31, elements for disturbance response are added to the constituent elements of the feedback control system.

Regarding a configuration for controlling the X-axis actuator 3, the noninteracting control section 31 includes an adder 56 and a phase compensating section 41 as constituent elements of an X-axis feedback control system, and includes a gain 50, a gain 51, a Z-X axis disturbance response 44, and a Y-X axis disturbance response 45 as elements for disturbance response.

The gain 50 multiplies the Z-axis target value by a predetermined factor. The Z-X axis disturbance response 44 performs a computation based on formula 4 where the disturbance r is the output of the gain 50, and determines the influence of the dynamic behavior of the Z-axis mechanism on the operation of the X-axis mechanism. The gain 51 multiplies the Y-axis target value by a predetermined factor. The Y-X axis disturbance response 45 performs a computation based on formula 4 where the disturbance r is the output of the gain 51, and determines the influence of the dynamic behavior of the Y-axis mechanism on the operation of the X-axis mechanism.

The adder 56 adds the outputs of the Z-X axis disturbance response 44 and the Y-X axis disturbance response 45, as correction values for compensating for interference from the Z-axis mechanism and the Y-axis mechanism, to the X-axis target value from the real-time target value arithmetic section 30 so as to eliminate the influence of the interference from the Z-axis mechanism and the Y-axis mechanism. Further, the adder 56 calculates a deviation between the corrected X-axis target value and the X-axis displacement Yx. The calculated deviation is inputted to the phase compensating section 41. The phase compensating section 41 performs phase compensation such as proportion/integration (PI) and proportion/integration/differentiation (PID) on the deviation. Thus, the phase compensating section 41 generates an X-axis command signal including components for eliminating the interference from the Z-axis mechanism and the Y-axis mechanism. The X-axis command signal is inputted to the amplifier 32.

The noninteracting control section 31 further includes an adder 57 and a phase compensating section 42 as constituent elements of a Y-axis feedback control system, and includes a gain 52, a gain 53, an X-Y axis disturbance response 46, and a Z-Y axis disturbance response 47 as elements for disturbance response.

The gain 52 multiplies the X-axis target value by a predetermined factor. The X-Y axis disturbance response 46 performs a computation based on formula 4 where the disturbance r is the output of the gain 52, and determines the influence of the dynamic behavior of the X-axis mechanism on the operation of the Y-axis mechanism. The gain 53 multiplies the Z-axis target value by a predetermined factor. The Z-Y axis disturbance response 47 performs a computation based on formula 4 where the disturbance r is the output of the gain 53, and determines the influence of the dynamic behavior of the Z-axis mechanism on the operation of the Y-axis mechanism.

The adder 57 adds the outputs of the X-Y axis disturbance response 46 and the Z-Y axis disturbance response 47, as correction values for compensating for interference from the X-axis mechanism and the Z-axis mechanism, to the Y-axis target value from the real-time target value arithmetic section 30 so as to eliminate the influence of the interference from the X-axis mechanism and the Z-axis mechanism. Further, the adder 57 calculates a deviation between the corrected Y-axis target value and the Y-axis displacement Yy. The calculated deviation is inputted to the phase compensating section 42. The phase compensating section 42 performs phase compensation such as PI and PID on the deviation. Thus, the phase compensating section 42 generates a Y-axis command signal including components for eliminating the interference from the X-axis mechanism and the Z-axis mechanism. The Y-axis command signal is inputted to the amplifier 33.

Moreover, the noninteracting control section 31 includes an adder 58 and a phase compensating section 43 as constituent elements of a Z-axis feedback control system, and includes a gain 54, a gain 55, a Y-Z axis disturbance response 48, and an X-Z axis disturbance response 49 as elements for disturbance response.

The gain 54 multiplies the Y-axis target value by a predetermined factor. The Y-Z axis disturbance response 48 performs a computation based on formula 4 where the disturbance r is the output of the gain 54, and determines the influence of the dynamic behavior of the Y-axis mechanism on the operation of the Z-axis mechanism. The gain 55 multiplies the X-axis target value by a predetermined factor. The X-Z axis disturbance response 49 performs a computation based on formula 4 where the disturbance r is the output of the gain 55, and determines the influence of the dynamic behavior of the X-axis mechanism on the operation of the Z-axis mechanism.

The adder 58 adds the outputs of the Y-Z axis disturbance response 48 and the X-Z axis disturbance response 49, as correction values for compensating for interference from the Y-axis mechanism and the X-axis mechanism, to the Z-axis target value from the real-time target value arithmetic section 30 so as to eliminate the influence of the interference from the Y-axis mechanism and the X-axis mechanism. Further, the adder 58 calculates a deviation between the corrected Z-axis target value and the Z-axis displacement Yz. The calculated deviation is inputted to the phase compensating section 43. The phase compensating section 43 performs phase compensation such as PI and PID on the deviation. Thus, the phase compensating section 43 generates a Z-axis command signal including components for eliminating the interference from the Y-axis mechanism and the X-axis mechanism. The Z-axis command signal is inputted to the amplifier 34.

Formula 2 required for determining formula 4 is an example in which the phase compensating section 61 performs PI control. Thus, the formula of the transfer function G1 has to be changed according to the processing contents of the phase compensating sections 41, 42, and 43.

It is difficult to determine the X-axis, Y-axis, and Z-axis models, that is, the transfer functions of the X-axis, Y-axis, and Z-axis mechanisms based on the physical quantities of the constituent elements of the X-axis, Y-axis, and Z-axis mechanisms. Thus, the transfer functions of the X-axis, Y-axis, and Z-axis mechanisms are determined by measuring frequency responses from the outputs of the amplifiers 32, 33, and 34 to the X-axis displacement Yx, the Y-axis displacement Yy, and the Z-axis displacement Yz, and identifying the frequency responses through the second-order lag system. In formula 3, A, B and C are parameters having been determined by the identification.

Since it is difficult to determine the magnitude of the actual disturbance r (interference) beforehand, it is necessary to empirically adjust the optimum value. The gains 50 to 55 are provided for the adjustment.

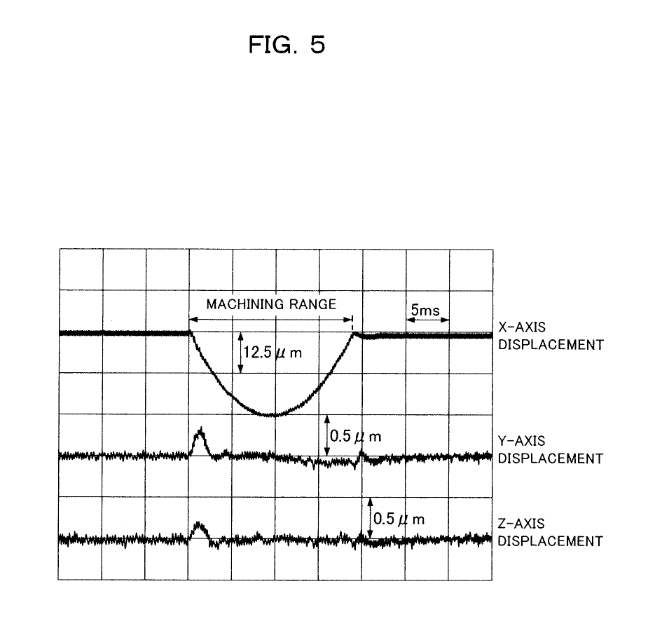

FIG. 5 shows an example of the operation of the tool 7 controlled by the controller of the three-axis tool unit according to the foregoing first embodiment. To be specific, FIG. 5 shows the operation of the tool 7 when the X-axis actuator 3 is fed with a half-wave voltage signal of a sin wave having a frequency of about 26 Hz and an amplitude of 25 μm. Comparing FIG. 5 with FIG. 17, it is understood that the influence of interference from the X-axis mechanism to the Y-axis mechanism and the Z-axis mechanism is considerably reduced.

As has been discussed, the controller of the three-axis tool unit according to the first embodiment can minutely operate the tool independently in the three axial directions and can compensate for mutual interference caused by the dynamic behaviors of the X-axis, Y-axis, and Z-axis mechanisms. Thus, by using the controller of the three-axis tool unit according to the first embodiment, machining can be precisely performed on the order of nanometers.

### Second Embodiment

Referring to FIG. 1, a controller of a three-axis tool unit according to a second embodiment will be described below.

In the first embodiment, the noninteracting control section 31 determines the magnitude of mutual influence (the influence of interference) of the dynamic behaviors of the respective axes (X-axis, Y-axis, and Z-axis mechanisms) based on the target values of the X-axis, Y-axis, and Z-axis actuators, and corrects the target values of the X-axis, Y-axis, and Z-axis actuators so as to eliminate the influence of interference. In the second embodiment, a noninteracting control section 31 includes a multivariable control algorithm. In other words, the noninteracting control section 31 controls X-axis, Y-axis, and Z-axis actuators by using a control model including an interference model expressed by transfer functions indicating the mutual interference (the influence of interference) of the dynamic behaviors of X-axis, Y-axis, and Z-axis mechanisms. To be specific, inputs to three axes (the X-axis, Y-axis, and Z-axis actuators) are used for determining the output (displacement) of one axis (actuator). Thus, a control system of multivariable control is configured with three inputs and three outputs. The second embodiment is different from the first embodiment only in this point and other configurations are similar to the configurations of the first embodiment. The following will describe the different point from the first embodiment.

The second embodiment will describe an example in which a model predictive control algorithm is mounted as a multivariable control algorithm. Model predictive control is a control method for deriving a change of manipulated variable for minimizing a deviation between a predicted value and a target value, while predicting the response of a system at each sampling time. Model predictive control can optimize the system in real time.

The following will specifically describe model predictive control.

In model predictive control, a behavior of a controlled variable in a certain interval (prediction interval P), which starts from a current time k, is predicted using inputs (manipulated variables) added to a control target before the current time k, data on outputs (controlled variables) observed before the current time k, and dynamic models. In the second embodiment, the behaviors of the outputs (controlled variables) of sensors 8, 9, and 10 are predicted using the outputs (manipulated variables) of amplifiers 32, 33 and 34 before the current time k, the outputs (controlled variables) of the sensors 8, 9, and 10 before the current time k, and the dynamic models (an X-axis model 21, a Y-axis model 22, a Z-axis model 23, and the models of interference terms 24 to 29) of a three-axis tool unit 1.

Moreover, during the prediction, the manipulated variable of a limited interval (an interval M for determining manipulated variables) including the current time k is determined such that a predicted value comes as close to a desired behavior as possible under restrictions on manipulated variables and controlled variables. In the second embodiment, the outputs (manipulated variables) of the amplifiers 32, 33, and 34 are determined such that the outputs (controlled variables) of the sensors 8, 9, and 10 come as close to the target values of actuators 3, 4, and 5 as possible, the target values having been calculated by a real-time target value arithmetic section 30.

Of the manipulated variables calculated in the determination interval M, only a manipulated variable u(k) at the current time k is actually added to the control target.

At the subsequent sampling time, the prediction interval P of controlled variables and the determination interval M of manipulated variables are shifted by one step, and then controlled variables are predicted and manipulated variables are determined again.

In model predictive control, the steps of solving an open loop optimization problem are thus repeated while the prediction interval of outputs (controlled variables) and the interval for determining inputs (manipulated variables) are advanced by one step at each sampling time.

The X-axis model 21, the Y-axis model 22, and the Z-axis model 23 can be expressed by a second-order lag system. The models of the interference terms 24 to 29 (interference models) can be also expressed by the second-order lag system. The dynamic model of the three-axis tool unit 1 is expressed by formula 5 below:

$$[ \begin{matrix}{Y}_{x} \\ {Y}_{y} \\ {Y}_{z}\end{matrix} ] = [ \begin{matrix}\frac{{N}_{x}}{{M}_{x} {s}^{2} + {D}_{x} s + {K}_{x}} & \frac{{E}_{yx}}{{A}_{yx} {s}^{2} + {B}_{yx} s + {C}_{yx}} & \frac{{E}_{zx}}{{A}_{zx} {s}^{2} + {B}_{zx} s + {C}_{zx}} \\ \frac{{E}_{xy}}{{A}_{xy} {s}^{2} + {B}_{xy} s + {C}_{xy}} & \frac{{N}_{y}}{{M}_{y} {s}^{2} + {D}_{y} s + {K}_{y}} & \frac{{E}_{zy}}{{A}_{zy} {s}^{2} + {B}_{zy} s + {C}_{zy}} \\ \frac{{E}_{xz}}{{A}_{xz} {s}^{2} + {B}_{xz} s + {C}_{xz}} & \frac{{E}_{yz}}{{A}_{yz} {s}^{2} + {B}_{yz} s + {C}_{yz}} & \frac{{N}_{z}}{{M}_{z} {s}^{2} + {D}_{z} s + {K}_{z}}\end{matrix} ] [ \begin{matrix}{u}_{x} \\ {u}_{y} \\ {u}_{z}\end{matrix} ] \qquad ( 5 )$$

where uₓ, u_{y}, and u_{z} are inputs to the three-axis tool unit 1 (the outputs of the amplifiers 32, 33, and 34), Yₓ, Y_{y}, and Y_{z} are the outputs of the three-axis tool unit 1 (the outputs of the sensors 8, 9, and 10), Mₓ, Dₓ, Kₓ, and Nₓ are parameters for the basic operations of the X-axis actuator 3, M_{y}, D_{y}, K_{y}, and N_{y} are parameters for the basic operations of the Y-axis actuator 4, M_{z}, D_{z}, K_{z}, and N_{z} are parameters for the basic operations of the Z-axis actuator 5, A_{yx}, B_{yx}, C_{yx}, and E_{yx} are parameters for the Y-X axis interference term 26, A_{zx}, B_{zx}, C_{zx}, and E_{zx} are parameters for the Z-X axis interference term 24, A_{xy}, B_{xy}, C_{xy}, and E_{xy} are parameters for the X-Y axis interference term 25, A_{zy}, B_{zy}, C_{zy}, and E_{zy} are parameters for the Z-Y axis interference term 28, A_{xz}, B_{xz}, C_{xz}, and E_{xz} are parameters for the X-Z axis interference term 29, and A_{yz}, B_{yz}, C_{yz}, and E_{yz} are parameters for the Y-Z axis interference term 27.

In formula 5, (1, 1) term corresponds to the X-axis model 21, (2, 2) term corresponds to the Y-axis model 22, (3, 3) term corresponds to the Z-axis model 23, (1, 2) term corresponds to the Y-X axis interference term 26 indicating the influence of the dynamic behavior of the Y-axis mechanism on the operation of the X-axis mechanism, (1, 3) term corresponds to the Z-X axis interference term 24 indicating the influence of the dynamic behavior of the Z-axis mechanism on the operation of the X-axis mechanism, (2, 1) term corresponds to the X-Y axis interference term 25 indicating the influence of the dynamic behavior of the X-axis mechanism on the operation of the Y-axis mechanism, (2, 3) term corresponds to the Z-Y axis interference term 28 indicating the influence of the dynamic behavior of the Z-axis mechanism on the operation of the Y-axis mechanism, (3, 1) term corresponds to the X-Z axis interference term 29 indicating the influence of the dynamic behavior of the X-axis mechanism on the operation of the Z-axis mechanism, and (3, 2) term corresponds to the Y-Z axis interference term 27 indicating the influence of the dynamic behavior of the Y-axis mechanism on the operation of the Z-axis mechanism.

It is difficult to calculate the X-axis, Y-axis, and Z-axis models and the models of mutual interference terms based on physical quantities. Thus, these models (transfer functions) are derived by identification from the measurement results of frequency response.

The identification of the X-axis model 21, the Y-axis model 22, and the Z-axis model 23 will be described below. The X-axis model 21 is taken as an example in the following explanation. In a state in which the X-axis actuator 3 is controlled in an open loop, a test signal is inputted to the amplifier 32 for the X axis, a frequency response is measured with the amplifier 32 having an output expressed as an input uₓ at that time and an X-axis displacement (the output of the sensor 8) expressed as an output Yₓ at that time, and the X-axis model 21 is identified based on the measurement result of the frequency response. The Y-axis model 22 and the Z-axis model 23 can be similarly identified.

The identification of the models of mutual interference terms will be described below. In the following explanation, the model of the X-Y axis interference term 25 of (2, 1) term in formula 5 is taken as an example. In a state in which feedback control is performed on the X-axis actuator 3 and the Y-axis actuator 4 is not controlled, a test signal is inputted to the amplifier 32 for the X axis, a frequency response is measured with the amplifier 32 having an output expressed as the input uₓ at that time and a Y-axis displacement (the output of the sensor 9) expressed as the output Y_{y} at that time, and the model of the X-Y axis interference term 25 is identified based on the measurement result of the frequency response. Other models of the interference terms can be similarly identified.

Formula 5 is expressed by a transfer function of a continuous system. In addition to the transfer function of the continuous system, processing may be performed using a transfer function discretized by Z conversion through bilinear conversion and so on. In other words, digital control may be performed using a micro processing unit (MPU) and the like.

In order to determine the optimum input to the three-axis tool unit 1, an evaluation function for determining a manipulated variable is expressed by formula 6 below. In this case, an input change Δuₙ is given by formula 7 below.

(yr−yp)^{t}Q(yr−yp)+Δuₙ^{t}RΔuₙ (6)

ΔUₙ=(A_{F}^{T}QA_{F}+R)⁻¹A_{F}^{T}Q(yr−yp) (7)

where yr is a reference orbit, yp is a predictive control output, Δuₙ is the input change, Q and R are weighting matrices, and AF is a step response matrix.

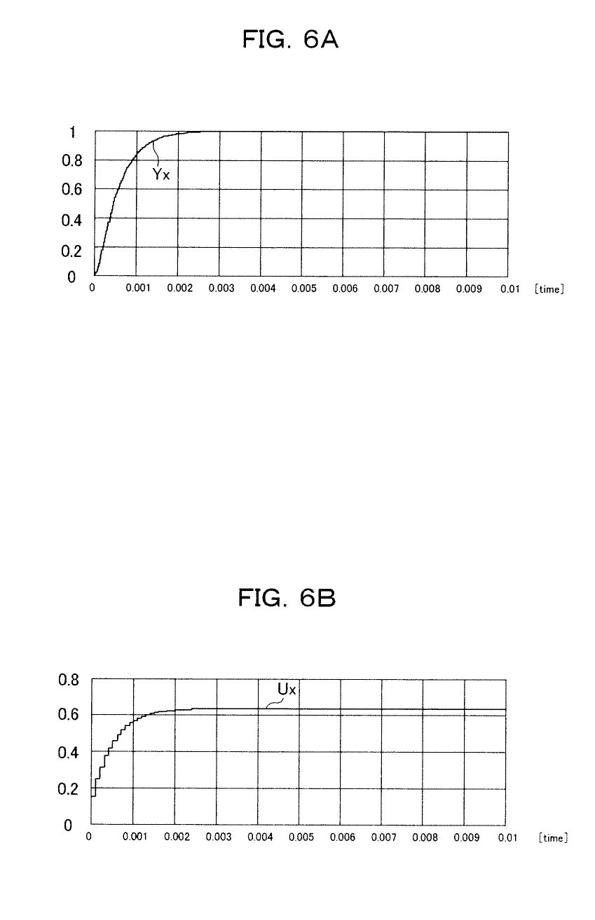

FIGS. 6A and 6B show the simulation results of step response in which specific parameters for model predictive control are a reference orbit time constant T_{ref}=0.001 sec, a sampling period Ts=0.0001 sec, a point of agreement P=8, and a control horizon M=1, and the X-axis, Y-axis, and Z-axis actuators 3, 4, and 5 have the same target value. FIG. 6A shows the output Yₓ of the X-axis sensor 8 and FIG. 6B shows the input uₓ to the X-axis actuator 3. As shown in FIGS. 6A and 6B, the X-axis actuator 3 is controlled without interference from the Y-axis and Z-axis mechanisms.

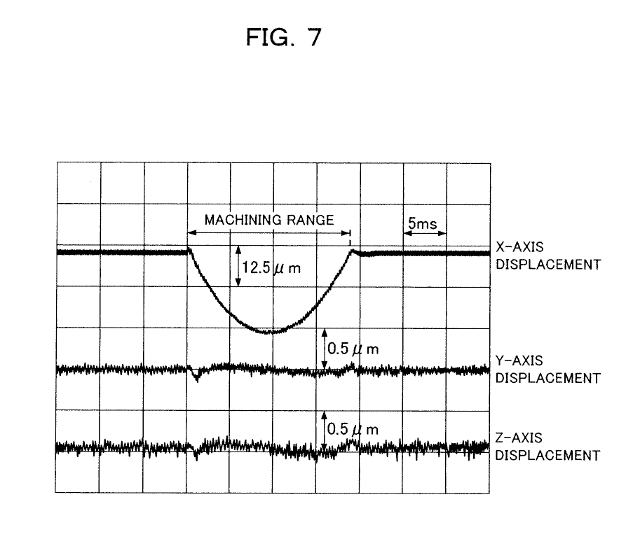

FIG. 7 shows an example of the operation of the tool 7 which is controlled by the controller of the three-axis tool unit according to the foregoing second embodiment. To be specific, FIG. 7 shows the operation of the tool 7 when the X-axis actuator 3 is fed with a half-wave voltage signal of a sin wave having a frequency of about 26 Hz and an amplitude of 25 μm. Comparing FIG. 7 with FIG. 17, it is understood that the influence of interference from the X-axis mechanism on the Y-axis mechanism and the Z-axis mechanism is considerably reduced.

As has been discussed, as in the first embodiment, the controller of the three-axis tool unit according to the second embodiment can minutely operate the tool independently in the three axial directions and can compensate for mutual interference caused by the dynamic behaviors of the X-axis, Y-axis, and Z-axis mechanisms. Thus, by using the controller of the three-axis tool unit according to the second embodiment, machining can be precisely performed on the order of nanometers.

### Third Embodiment

A working machine of a third embodiment will be described below in accordance with the accompanying drawings. The same members as in the first and second embodiments will be indicated by the same reference numerals and the explanation thereof is omitted.

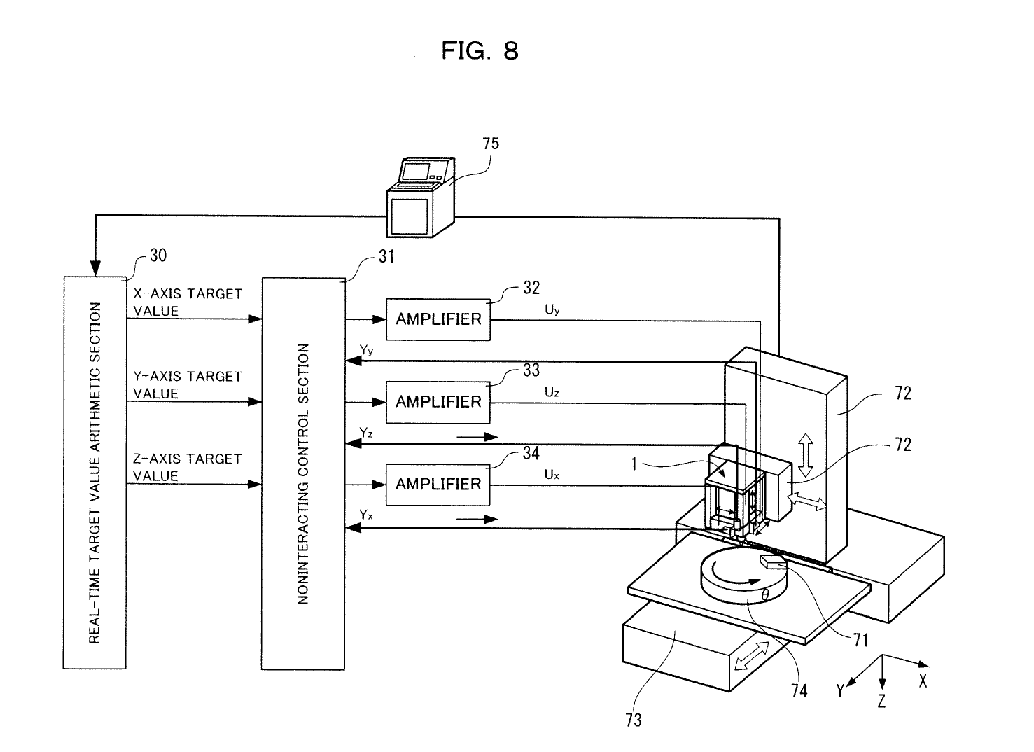

FIG. 8 is a structural diagram showing the working machine according to the third embodiment of the present invention. As shown in FIG. 8, the working machine includes a three-axis tool unit 1 and a controller thereof. In the following explanation, the controller of the three-axis tool unit according to the second embodiment is mounted.

As linear stages for relatively moving the three-axis tool unit 1 in three axial directions (X, Y and Z axes) orthogonal to a workpiece 71, the working machine includes an X/Z axis table 72 for moving the three-axis tool unit 1 in the X-axis direction and the Z-axis direction and a Y-axis table 73 for moving the three-axis tool unit 1 in the Y-axis direction. Further, as a rotary stage for making the three-axis tool unit 1 circulate relative to the workpiece 71, the working machine includes a rotary table 74 for making the workpiece 71 circulate. The X/Z axis table 72, the Y-axis table 73, and the rotary table 74 are NC tables on which three axes (three-axis coordinates) and center axes (angular coordinates) are numerically controlled by an NC controller 75.

In the following explanation, the three-axis tool unit is moved in the X-axis, Y-axis, and Z-axis directions but any configuration is applicable as long as at least one of the three-axis tool unit and the workpiece is moved in the X-axis, Y-axis, and Z-axis directions. Similarly, although the workpiece circulates in the following explanation, any configuration is applicable as long as at least one of the three-axis tool unit and the workpiece circulates. Moreover, one rotation axis is provided in the following explanation but at least two rotation axes may be provided.

The NC controller 75 performs numerical control on the three-axis coordinates (X, Y, Z coordinates) of the X/Z axis table 72 and the Y-axis table 73 and the angular coordinates (θ coordinates) of the rotary table 74 according to a machining program. During machining, the three-axis tool unit 1 moves in the three-axis directions relative to the workpiece 71 while circulating relative to the workpiece 71 under the numerical control of the NC controller 75. The working machine thus lathes the workpiece 71.

Generally, it is difficult to precisely operate the X/Z axis table 72 and the Y-axis table 73 at high speeds on the order of nanometers. Thus, in this working machine, a real-time target value arithmetic section 30 calculates X-axis, Y-axis and Z-axis target values in real time by using information about X, Y, Z, and θ coordinates from the NC controller 75 and formulas or point group data based on machining contents. A noninteracting control section 31 determines the outputs of amplifiers 32, 33, and 34 such that the outputs of sensors 8, 9, and 10 come as close as possible to the X-axis, Y-axis, and Z-axis target values having been calculated by the real-time target value arithmetic section 30.

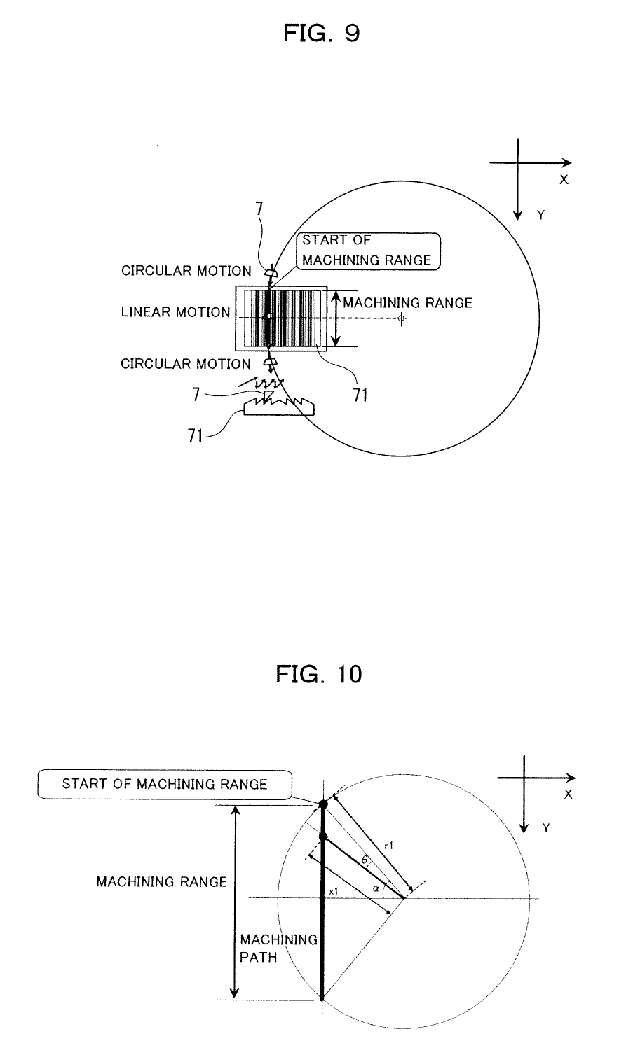

Referring to FIGS. 9 and 10, the following will describe an example of a machining method using the working machine. In this case, the workpiece 71 is machined into a cylindrical shape (diffracted cylindrical shape) having a linear diffraction grating. In order to lathe the workpiece 71 into this shape, as shown in FIG. 9, the tool 7 has to be operated in synchronization with the circular motion of the workpiece 71 so as to form a machining path of a straight line, which is circular in general.

In the definition of an angle in FIG. 10, a distance x1 can be determined by formula 8 below:

$$x 1 = \frac{r 1 \cdot cos α}{cos ( α - θ )} \qquad ( 8 )$$

Thus, the X-axis target value can be determined by formula 9 below:

X-axis target value=r1−x1 (9)

The real-time target value arithmetic section 30 calculates the X-axis target value as follows:
(1) A rotation angle (rotation angle 1) is stored at a point where the workpiece 71 enters a machining range (a range for machining the workpiece 71).
(2) An angle α is determined based on “rotation angle 1” and “B-axis angle at the center of the machining range”.
(3) An angle θ is determined based on the rotation angle 1 and the current angle.
(4) The distance x1 is determined based on r1, α, θ and formula 8.
(5) The X-axis target value is determined based on formula 9.

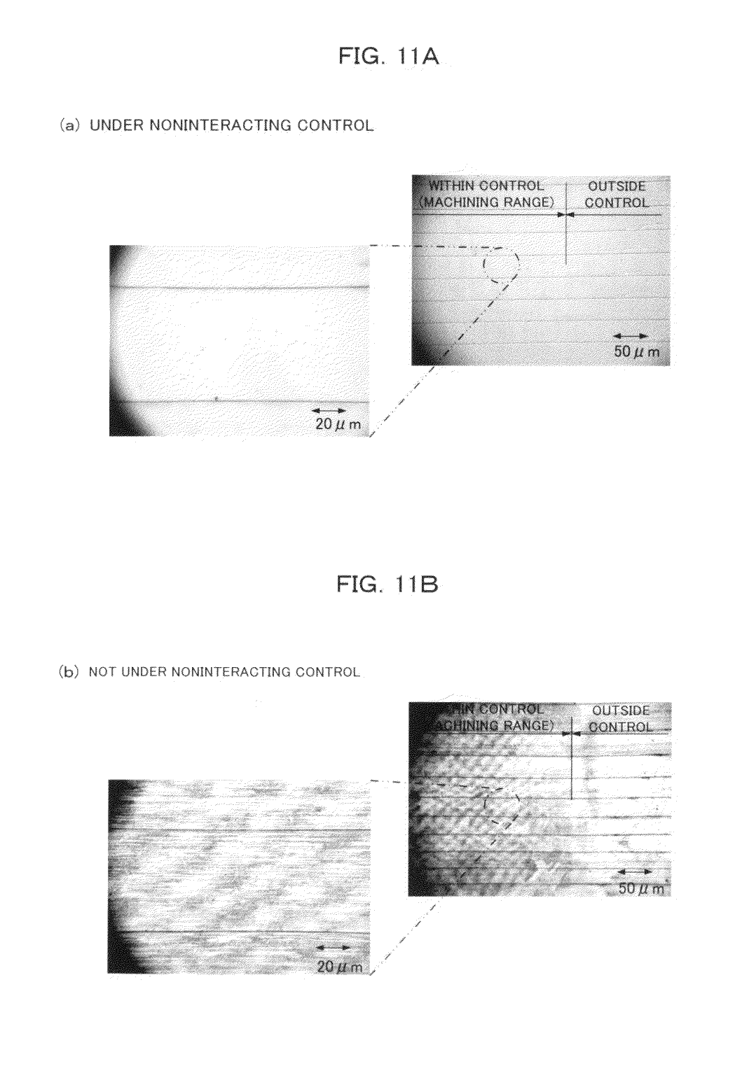

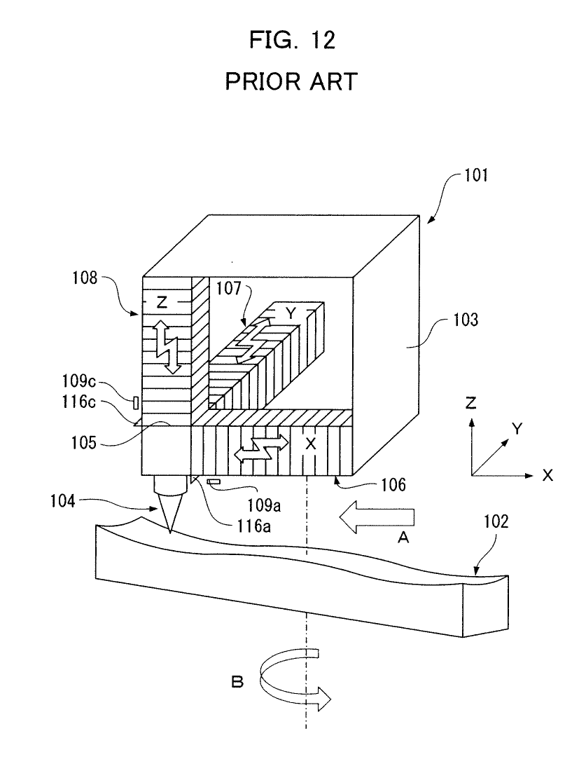

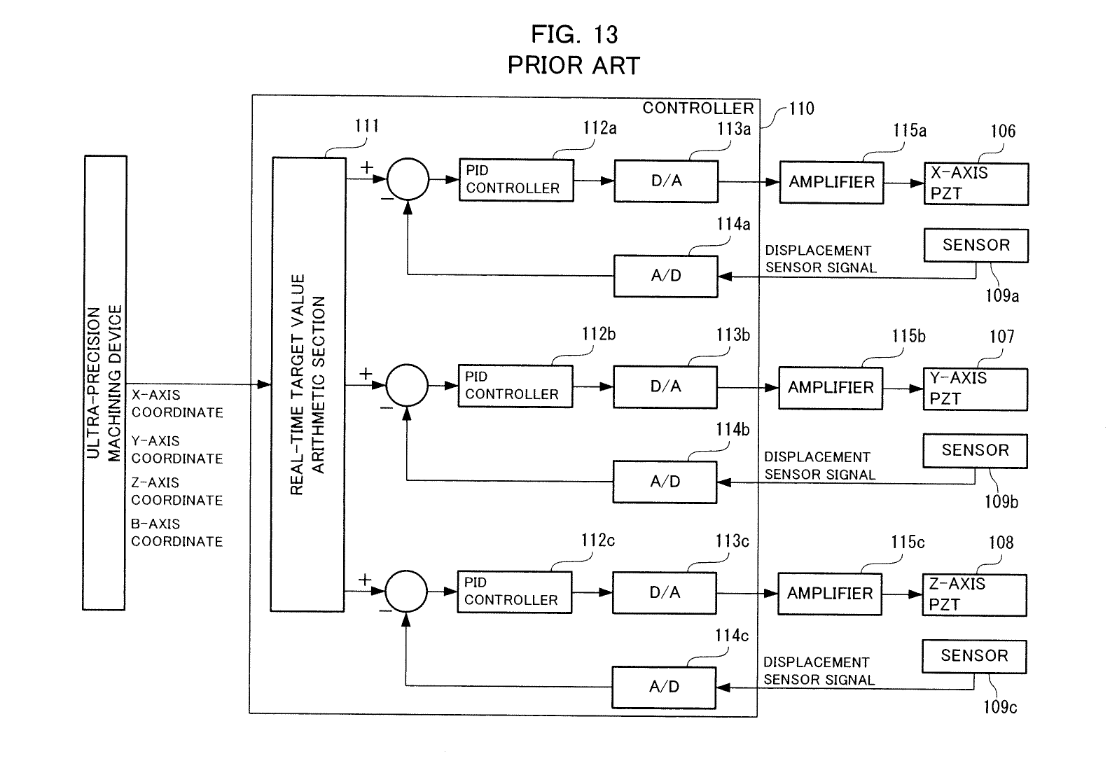

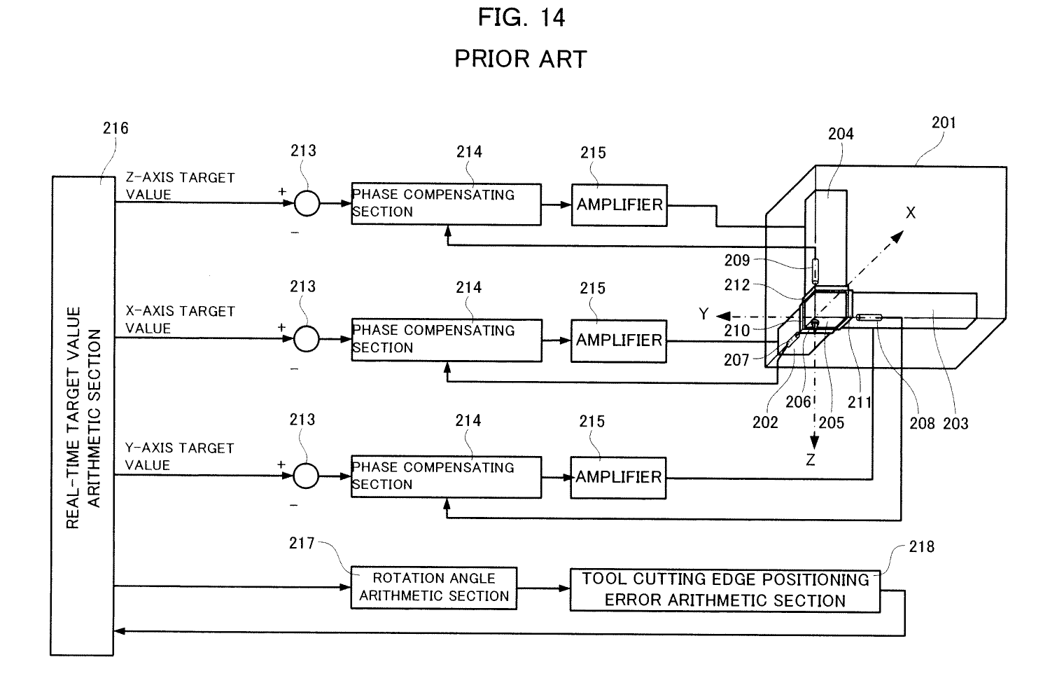

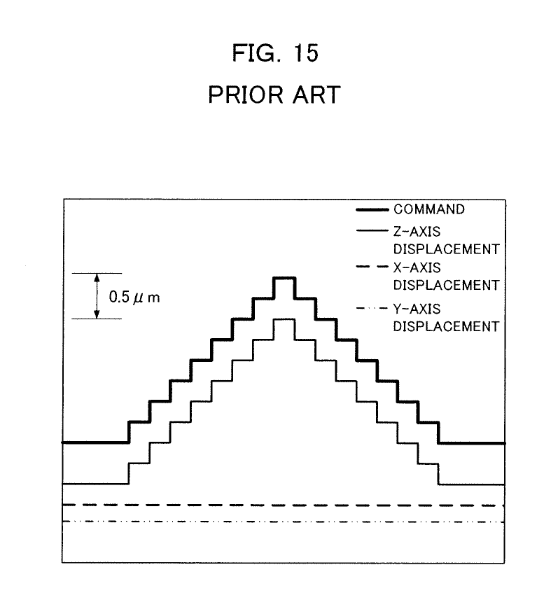

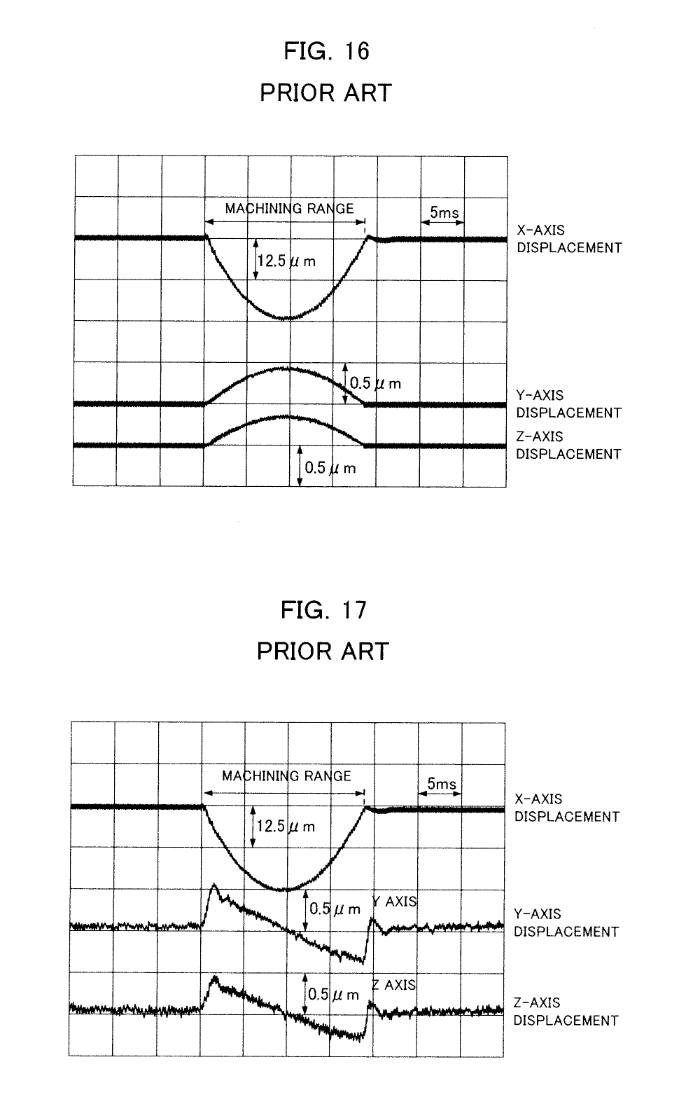

FIGS. 11A and 11B show machining results obtained when the X-axis actuator 3 is fed with a half-wave voltage signal of a sin wave having a frequency of about 26 Hz and an amplitude of 25 μm and the X-axis actuator 3 is operated such that a machining path, which is circular in general, becomes a straight line. FIG. 11A shows machining results obtained when noninteracting control is performed. FIG. 11B shows machining results obtained when noninteracting control is not performed. When noninteracting control is performed, the influence of interference from an X-axis mechanism on a Y-axis mechanism and a Z-axis mechanism is considerably reduced as shown in FIG. 7, so that a clear straight line is formed as shown in FIG. 11A. On the other hand, when noninteracting control is not performed, the Y-axis mechanism and the Z-axis mechanism are operated under the influence of the dynamic behavior of the X-axis mechanism as shown in FIG. 17, so that accuracy of the straight line decreases as shown in FIG. 11B.

As has been discussed, the working machine of the third embodiment can machine precision components such as an optical component having a nonaxisymmetric aspherical shape, which has required quite a long machining time in a method of the prior art, by an axisymmetric machining method typified by lathe turning. Thus, the machining time of a nonaxisymmetric aspherical shape is considerably reduced. Moreover, the working machine of the third embodiment can minutely operate a tool independently in the three axial directions and compensate for mutual interference caused by the dynamic behaviors of the X-axis, Y-axis, and Z-axis mechanisms. It is therefore possible to achieve precise machining on the order of nanometers.

Thus, the working machine of the third embodiment can be used for machining general optical devices. Particularly, according to the working machine of the third embodiment, a complicated shape having a diffraction grating and the like can be precisely machined in a short time. Moreover, the working machine of the third embodiment is widely applicable to machining of dies for components which require a number of repeated shapes as a display and the like.

In the foregoing explanation, the controller of the three-axis tool unit according to the second embodiment is mounted. The controller of the three-axis tool unit according to the first embodiment can also obtain the same effect.

What is claimed is:

1. A controller of a three-axis tool unit comprising:
first, second, and third actuators operating in first, second, and third directions orthogonal to one another;
a tool holder disposed at an intersection of axes of operating directions of the first, second, and third actuators;
a tool attached to the tool holder to operate in the first, second, and third directions according to operations of the first, second, and third actuators; and
first, second, and third sensors for measuring displacements of the first, second, and third actuators, the controller controlling the operations of the first, second, and third actuators of the three-axis tool unit;
wherein the controller of the three-axis tool unit comprises a noninteracting control section which calculates, by using transfer functions, correction values for compensating for mutual interference caused by dynamic behaviors of a first mechanism including the first actuator, the tool holder, and the tool, a second mechanism including the second actuator, the tool holder, and the tool, and a third mechanism including the third actuator, the tool holder, and the tool, corrects target displacements of the first, second, third actuators by using the correction values, and controls the operations of the first, second, and third actuators by using the corrected target displacements and the displacements measured by the first, second, and third sensors, the transfer functions indicating mutual influence of the dynamic behaviors of the first, second, and third mechanisms.

2. The controller of the three-axis tool unit according to claim 1, wherein the transfer functions indicating the mutual influence of the dynamic behaviors of the first, second, and third mechanisms are identified based on response measurement results.

3. The controller of the three-axis tool unit according to claim 1, wherein the first, second, and third sensors are disposed such that axes of sensing directions of the sensors intersect at one point.

4. A controller of a three-axis tool unit comprising:
first, second, and third actuators operating in first, second, and third directions orthogonal to one another;
a tool holder disposed at an intersection of axes of operating directions of the first, second, and third actuators;
a tool attached to the tool holder to operate in the first, second, and third directions according to operations of the first, second, and third actuators; and
first, second, and third sensors for measuring displacements of the first, second, and third actuators,
the controller controlling the operations of the first, second, and third actuators of the three-axis tool unit;
wherein the controller of the three-axis tool unit comprises a noninteracting control section including a multivariable control algorithm for controlling the operations of the first, second, and third actuators by using models of a first mechanism including the first actuator, the tool holder, and the tool, a second mechanism including the second actuator, the tool holder, and the tool, and a third mechanism including the third actuator, the tool holder, and the tool, interference models indicating mutual influence of dynamic behaviors of the first, second, and third mechanisms, target displacements of the first, second, and third actuators, and displacements measured by the first, second, and third sensors.

5. The controller of the three-axis tool unit according to claim 4, wherein the noninteracting control section includes a model predictive control algorithm as the multivariable control algorithm.

6. The controller of the three-axis tool unit according to claim 4, wherein the models of the first, second and third mechanisms and the interference models are expressed by transfer functions, and the transfer functions are identified based on response measurement results.

7. The controller of the three-axis tool unit according to claim 4, wherein the first, second, and third sensors are disposed such that axes of sensing directions of the sensors intersect at one point.

8. A working machine comprising:
a three-axis tool unit comprising: first, second, and third actuators operating in first, second, and third directions orthogonal to one another;
a tool holder disposed at an intersection of axes of operating directions of the first, second, and third actuators;
a tool attached to the tool holder to operate in the first, second, and third directions according to operations of the first, second, and third actuators; and
first, second, and third sensors for measuring displacements of the first, second, and third actuators;
a linear stage for relatively moving the three-axis tool unit in three axial directions orthogonal to a workpiece;
a rotary stage for making the three-axis tool unit circulate relative to the workpiece; and
the controller of the three-axis tool unit according to claim 1;
wherein the controller of the three-axis tool unit calculates target displacements of the first, second, and third actuators according to a relative displacement of the three-axis tool unit with respect to the workpiece, the relative displacement being made by the rotary stage and the linear stage, and the controller controls the operations of the first, second, and third actuators by using the calculated target displacements.

9. A working machine comprising:
a three-axis tool unit comprising: first, second, and third actuators operating in first, second, and third directions orthogonal to one another;
a tool holder disposed at an intersection of axes of operating directions of the first, second, and third actuators;
a tool attached to the tool holder to operate in the first, second, and third directions according to operations of the first, second, and third actuators; and
first, second, and third sensors for measuring displacements of the first, second, and third actuators;
a linear stage for relatively moving the three-axis tool unit in three axial directions orthogonal to a workpiece;
a rotary stage for making the three-axis tool unit circulate relative to the workpiece; and
the controller of the three-axis tool unit according to claim 4;
wherein the controller of the three-axis tool unit calculates target displacements of the first, second, and third actuators according to a relative displacement of the three-axis tool unit with respect to the workpiece, the relative displacement being made by the rotary stage and the linear stage, and the controller controls the operations of the first, second, and third actuators by using the calculated target displacements.
